(19) United States
(12) Patent Application Publication
(10) Pub. No.: US 2002/0111871 A1
(43) Pub. Date: Aug. 15, 2002

(54) Method and system for implementing contract stores on a network

(76) Inventors: Shih-Ping Lin, Kaohsiung (TW); Chih-Hua Wang, Taipei (TW)

Correspondence Address: BIRCH STEWART KOLASCH & BIRCH, PO BOX 747, FALLS CHURCH, VA, 22040-0747, US

(21) Appl. No.: 09/779,734

(22) Filed: Feb. 9, 2001

(51) Int. Cl. G06F 17/60

(52) U.S. Cl. 705/26

(57) ABSTRACT

A method for implementing contract stores on a network. This method determines whether a consumer is a member of a specific group according to the data entered by the consumer when he logs in. When the consumer is a member of a specific group, he is viewed as a special member and a special price is provided when he quotes the price. The invention also provides a system for implementing this method.

### BACKGROUND OF THE INVENTION

1. Field of Invention

The invention relates to a method and the corresponding system for implementing contract stores on a network and, more particularly, to a method and system of network contract stores that can automatically determine whether a consumer should be treated as a special member according to his login data.

2. Related Art

As computer-related technologies have progressed, conducting electronic commerce (E-commerce) using the network has become a modern business trend. Generally speaking, E-commerce refers to a modern commercial activity whose purpose is to quickly make changes to fit the needs of the merchants or consumers, achieving the goals of lowering costs and increasing service quality. Taking the B2C E-commerce as a model, the merchants can use such features as the high speed and interactivity of computers and networks to perform all types of businesses for different consumers, including online advertising and marketing, online ordering, and online client services. The consumer can then compare prices or trade by browsing commodities and services provided by all merchants over the network.

Without a doubt, in such a competitive E-commerce environment, how to attract consumers to connect to the web store of a merchant has become an important subject. In the prior art, the methods to attract the consumers to connect to the web stores include lottery or clearance activities. Such methods can temporarily attract the consumer's attention, yet the consumers may still trade with other web stores once the activities are over. In other words, such methods cannot continuously attract the consumers over a long period of time.

Moreover, some merchants also take the strategy of classifying members into different categories. For example, if the member is a student, then he is allowed to purchase commodities and services provided by the merchant at cheaper prices than normal members. However, the consumer has to go through complicated verification processes. The consumer has to verify his identity in writing first so as to enjoy lower prices. This often lowers consumer's interest in purchases at the website.

### SUMMARY OF THE INVENTION

Pursuant to the above-mentioned problems, it is then an object of the invention to provide a method and system for implementing contract stores on a network that can continuously attract consumers to connect to the web store over a long period of time. Its verification procedure is simplified so that consumers are more willing to purchase at the website.

To achieve the above object, the disclosed method includes a login procedure, a verification procedure and a special price providing procedure. The login procedure allows a consumer to log on through a network. The verification procedure verifies whether the entered data in the login procedure by the consumer is a member of a specific group. When the consumer is indeed a member of a specific unit, then he will be treated as a special member. The special price providing procedure offers special prices through the network to the special member when he quote prices.

The invention also discloses a system for implementing contract stores on a network. The system includes a login module, a verification module, and a special price providing module. The login module allows a consumer to log on through the network. The verification module verifies whether the entered data in the login procedure by the consumer is a member of a specific group. When the consumer is indeed a member of a specific group, then he will be treated as a special member. The special price providing module offers special prices through the network to the special member when he quote prices.

### BRIEF DESCRIPTION OF THE DRAWINGS

The invention will become more fully understood from the detailed description given hereinbelow illustration only, and thus are not limitative of the invention, and wherein:

FIG. 1 is a flowchart showing the procedure of the method for implementing contract stores on a network according to a preferred embodiment of the invention;

FIG. 2(A) is a schematic view showing the situation of providing normal consumers commodity information according to the method shown in FIG. 1;

FIG. 2(B) is a schematic view showing the situation of providing special members commodity information according to the method shown in FIG. 1; and

FIG. 3 is a schematic view showing a structure of the system for implementing contract stores on a network according to a preferred embodiment of the invention.

### DETAILED DESCRIPTION OF THE INVENTION

The disclosed method and system for implementing contract stores on a network will be apparent from the following detailed description, which proceeds with reference to the accompanying drawings, wherein the same references relate to the same elements.

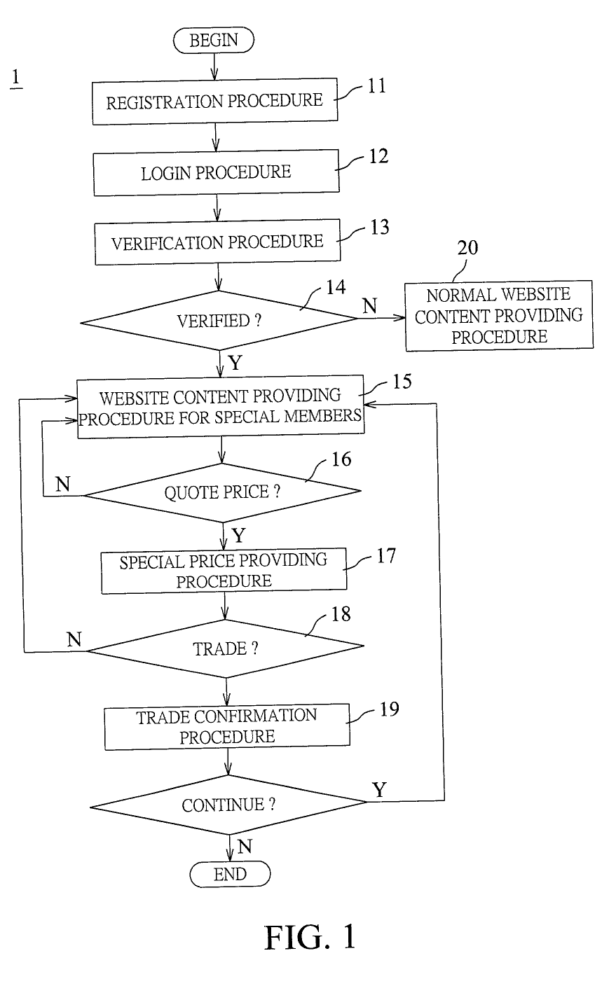

With reference to FIG. 1, the method 1 for implementing contract stores on a network according to a preferred embodiment of the invention first goes through a registration procedure 11 for consumers to register his basic data at the web store. The registered data are then stored in a consumer database. The registration procedure 11 can be any conventional registration method. For example, the merchant can use the ASP language to make a registration form, which is then provided to consumers through the Internet from a network server. The consumer can browse this registration form on a personal computer (PC) monitor and use the mouse to click or keyboard to type in data. Once the form is filled and the provided data are correct, the registration data are transmitted to the network server. After receiving the registration data, the merchant can then store it in a consumer database. The above description only involves the prior art and therefore is not further explained.

After the consumer registers, the method 1 enters a login procedure 12, which allows the consumer to log on to the web store of the merchant. In the login procedure 12, the web store receives the username and password from the consumer, searches the consumer data in the consumer database, and checks if they agree. If they agree, the consumer is allowed to log on.

It should be noted that in the login procedure 12, the consumer can directly log on to the network server of the web store, or he can log on to another network server before logging on to the network server where the web store is located. In other words, normal consumers can directly log on to the network server where the web store is located while specific members can log on to another network server and then enter the web store afterwards. This method can separate two different kinds of consumers.

In a verification procedure 13, the system further checks whether the consumer is a member of a specific unit according to the consumer data. The specific unit here refers to the one for which the web store is a contract store. For example, the specific group can be the government, enterprises, or clubs. The method for identifying the consumer as a member of the specific group in the current embodiment is done by checking his electronic mail (E-mail) address. For example, if the E-mail address format of a specific group is “[username]@joupo.com”, then when an E-mail address of such a format is received the verification procedure 13 can determine that the consumer with this E-mail is a member of this group from “joupo.com” appearing in the E-mail address.

The reasons for using E-mail addresses to determine whether the consumer is a member of the specific group are as follows. First, in the verification procedure 13, a verification message can be sent out to the E-mail address of the consumer and ask the consumer to reply. If the consumer replies, then this E-mail address is indeed owned by the consumer. Secondly, if the consumer is not a member of the specific group, then he cannot have such an E-mail address. Thirdly, once the consumer E-mail address is obtained, this E-mail address can be used again when the consumer wants to purchase an item. In summary, using consumer E-mail addresses to perform verification does not only quickly, conveniently and accurately determine the true identity of the consumer, but also ensure the validity and security of the trades.

Afterwards, in a verification determination procedure 14, if the consumer is not a member of the specific group, then a normal website content providing procedure 20 is performed for the consumer to browse the normal website contents. On the other hand, if the consumer is a member of a specific group, i.e., the consumer is a special member of the website, then a special member website content providing procedure 15 is performed for the special member to browse the website content.

It should be noted that in the special member website content providing procedure 15, the merchant can provide content that can be seen by special members only, such as special member only services, special member configured personal home pages, etc. However, its can also provide normal website contents as provided in the normal website content providing procedure 20. That is, normal consumers and special members will see the same content after they log on. The only difference is on the commodity or service prices.

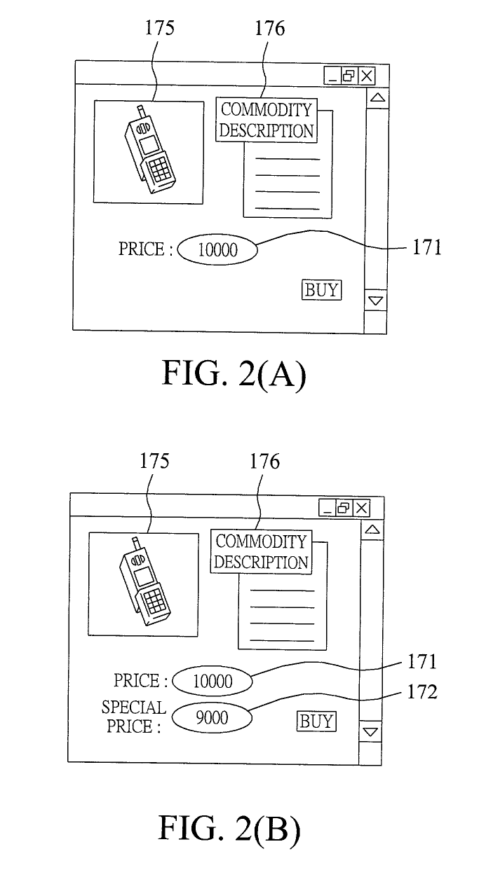

If the special member wants to quote the price of a specific commodity or service in a price quotation determination procedure 16, the system enters a special price providing procedure 17. In the special price providing procedure 17, the web store will provide a special price to the special member. With reference to both FIG. 2(A) and 2(B), one shows a commodity picture 175, a commodity description 176 and a price 171 for normal consumers (FIG. 2(A)); the other shows in addition a special price 172 that only special members can see (FIG. 2(B)).

If the special member determines to purchase in a trade determination procedure 18, then the procedure enters a trade confirmation procedure 19 to make sure that the consumer still has the special membership. As described hereinbefore, the trade confirmation procedure 19 can confirm with the consumer by sending out an E-mail message to the E-mail address, which the consumer uses to register, and asking him to reply. Afterwards, if the consumer wants to continue looking up other commodities, he can return to the website content providing procedure 15 for special members to browse other contents in the website.

In the trade confirmation procedure 19, if the consumer has left the specific group, then he loses the access to his old E-mail account and is thus unable to reply the E-mail message from the system. Therefore, the merchant can determine that the consumer is not a special member in this way and withdraw the special price. On the other hand, if the consumer is a member in the specific unit, then he would be able to reply to the E-mail message. The merchant can determine that the consumer is a special member and continue to complete the trade.

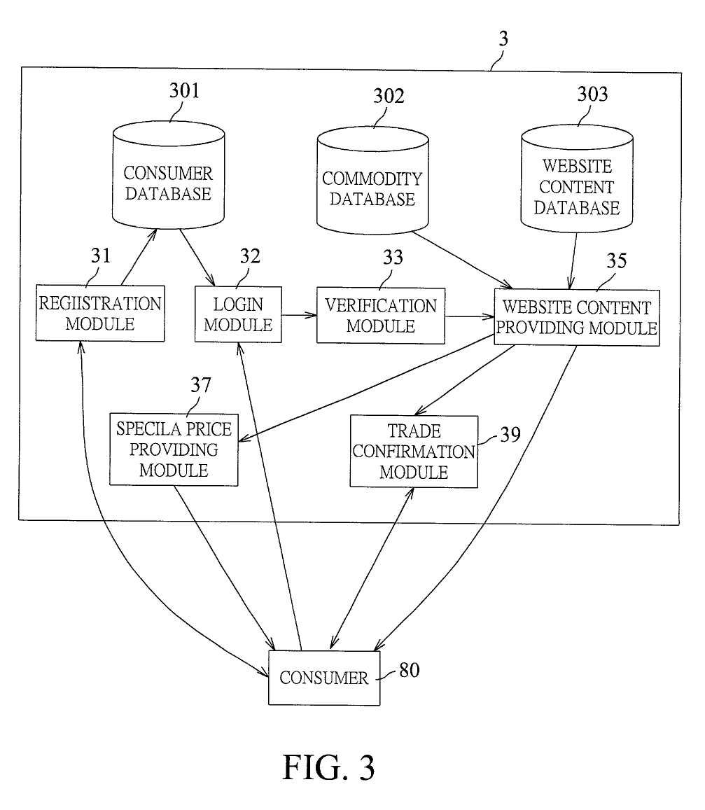

With reference to FIG. 3, the system 3 for implementing contract stores on a network according to a preferred embodiment of the invention includes a consumer database 301, a commodity database 302, a website content database 303, a registration module 31, a login module 32, a verification module 33, a website content providing module 35, a special price providing module 37, and a trade confirmation module 39. The consumer database 301 stores basic data of registered consumers 80, such as the usernames, E-mail addresses, and passwords. The commodity database 302 stores relevant data of all commodities, such as commodity descriptions and prices. The website content database 303 stores relevant data of the website contents, such as images, texts or hyperlinks. These three databases can be stored in any storage device, such as a hard disk drive (HDD) or a readable/writeable optical disk drive.

The registration module 31 allows consumers 80 to register their basic data and stores them into the consumer database 301. The login module 32 allows a consumer 80 to enter his username and password, searches in the consumer database 301 the corresponding stored consumer data, and checks if both of them agree. If they agree, then the consumer 80 can log on.

The verification module 33 further determines whether the consumer is a member of a specific group according to the consumer data. If he is, then the website content providing module 35 provide various contents to the special member (verified consumer 80) according to the data in the commodity database 302 and the website content database 303. The details of verification have been described hereinbefore and are not repeated here.

If the special member wants to quote the price of a particular commodity or service, then the special price providing module 37 will provides a special price to the special member. As mentioned before, after the special member determines to purchase this commodity, the trade confirmation module 39 performs confirmation by sending out an E-mail message to the E-mail address registered by the consumer and asking for a reply. If the consumer is still a member of the specific group, then he would be able to reply the message and the merchant can determine whether the consumer is a special member in this manner and continue to complete the trade.

In the network server where the web store is located, each module can be a program code stored in a storage device, such as an HDD or a readable/writeable optical disk drive, so that the central processing unit of the network server can perform the aforementioned registration procedure 11, login procedure 12, confirmation procedure 13, website content providing procedure 15, special price providing procedure 17, and trade confirmation procedure 19 after reading in the program codes for the registration module 31, the login module 32, the confirmation module 33, the website content providing module 35, the special price proving module 37, and the trade confirmation module 39.

It should be emphasized that although the preferred embodiment of the system 3 is on a single network server, those skilled in the art can implement the invention on multiple network servers to increase the speed and efficiency without departing from the spirit and scope of the invention.

According to the method and system for implementing contract stores on a network, certain people belonging to a specific unit are treated as special members that enjoy special prices. The invention uses the high interactivity of computer and network technologies to simplify verification procedures, thus increasing the desire of consumers to connect to the web store for shopping. The invention can also greatly increase the number of members in the web store, thus delivering effective advertising effect.

The method and system for implementing contract stores on a network can continuously attract consumers to connect to the web store, greatly increasing the profit.

Certain variations would be apparent to those skilled in the art, which variations are considered within the spirit and scope of the claimed invention.

What is claimed is:

1. A method applied to a web store for implementing contract stores on a network so that the web store becomes a contract store of at least one specific group, wherein the method comprises:
a login procedure, which allows a consumer to log on through the network;
a verification procedure, which checks whether the consumer is a member of the specific group according to the data entered by the consumer when he logs on and treating the consumer as a special member when he is indeed a member of the specific group; and
a special price providing procedure, which offers a special price to the special member through the network when the special member quotes the price of a commodity.

2. The method of claim 1, wherein the login procedure allows the special member to log on at the web store's website so as to connect to the web store through the network.

3. The method of claim 1, wherein the login procedure allows the special member to log on at another website and then connect to the web store.

4. The method of claim 1, wherein the data entered by the consumer in the login procedure include his E-mail account.

5. The method of claim 4, wherein the verification procedure determines whether the consumer is a member in the specific group according to his E-mail account.

6. The method of claim 1 further comprising a registration procedure, which receives basic data of the consumer and stores them in a consumer database, the basic data including the E-mail account of the consumer.

7. The method of claim 6, wherein the verification procedure determines whether the consumer is a member in the specific group according to his E-mail account information stored in the consumer database.

8. The method of claim 4 further comprising a trade confirmation procedure, which determines whether a trade activity is continued when the special member wants to trade.

9. The method of claim 8, wherein the trade confirmation procedure determines whether the trade activity is continued by sending out an E-mail message to the E-mail account of the special member and asking for a reply when the special member wants to trade.

10. The method of claim 6 further comprising a trade confirmation procedure, which determines whether a trade activity is continued when the special member wants to trade.

11. The method of claim 10, wherein the trade confirmation procedure determines whether the trade activity is continued by sending out an E-mail message to the E-mail account of the special member and asking for a reply when the special member wants to trade.

12. A method for implementing contract stores on a network to make a consumer a special member of a web store, wherein the method comprises:
a login procedure, which allows the consumer to log on to the web store through the network;
a verification procedure, which determines whether the consumer is a member of a specific group according to the data entered by the consumer in the login procedure and treating the consumer as a special member of the web store if he is determined to be a member in the specific group; and
a special price acceptance procedure, which accepts a special price offered by the web store through the network after quoting the price.

13. The method of claim 12, wherein the login procedure allows the special member to log on at the web store's website so as to connect to the web store through the network.

14. The method of claim 12, wherein the login procedure allows the special member to log on at another website and then connect to the web store.

15. The method of claim 12, wherein the data entered by the consumer in the login procedure include his E-mail account.

16. The method of claim 15, wherein the verification procedure determines whether the consumer is a member in the specific group according to his E-mail account.

17. The method of claim 12 further comprising a registration procedure, which receives basic data of the consumer and stores them in a consumer database, the basic data includes the E-mail account of the consumer.

18. The method of claim 17, wherein the verification procedure determines whether the consumer is a member in the specific group according to his E-mail account information stored in the consumer database.

19. The method of claim 15 further comprising a trade confirmation procedure, which accepts the confirmation made by the web store if the special member wants to trade.

20. The method of claim 19, wherein the trade confirmation procedure receives an E-mail message sent out by the web store to the E-mail account of the special member when the special member wants to trade.

21. The method of claim 17 further comprising a trade confirmation procedure, which accepts the confirmation made by the web store if the special member wants to trade.

22. The method of claim 21, wherein the trade confirmation procedure determines whether the trade activity is continued by sending out an E-mail message to the E-mail account of the special member and asking for a reply when the special member wants to trade.

23. A system for implementing contract stores on a network so as to make a web store the contract store of at least one specific group, wherein the system comprises:
a login module, which allows a consumer to log on;
a verification module, which determines whether the consumer is a member of the specific group according to the data entered by the consumer in the login procedure and treating the consumer as a special member when he is determined to be a member of the specific group; and
a special price providing module, which offers a special price to the special member when the special member quote the price of a commodity.

24. The system of claim 23, wherein the login module allows the special member to log on at the web store's website so as to connect to the web store through the network.

25. The system of claim 23, wherein the login module allows the special member to log on at another website and then connect to the web store.

26. The system of claim 23, wherein the data entered by the consumer in the login procedure include his E-mail account.

27. The system of claim 26, wherein the verification module determines whether the consumer is a member in the specific unit according to his E-mail account.

28. The system of claim 23 further comprising:
a consumer database; and
a registration module, which allows the consumer to register his basic data and stores the basic data into the consumer database, the basic data including the E-mail account of the consumer.

29. The system of claim 28, wherein the verification module determines whether the consumer is a member of the specific group according to the E-mail account stored in the consumer database.

30. The system of claim 26 further comprising a trade confirmation module, which determines whether a trade activity is continued when the special member wants to trade.

31. The system of claim 30, wherein the trade confirmation module determines whether the trade activity is continued by sending out an E-mail message to the E-mail account of the special member and asking for a reply when the special member wants to trade.

32. The system of claim 28 further comprising a trade confirmation module, which determines whether a trade activity is continued when the special member wants to trade.

33. The system of claim 32, wherein the trade confirmation module determines whether the trade activity is continued by sending out an E-mail message to the E-mail account of the special member and asking for a reply when the special member wants to trade.
